(19) United States
(12) Patent Application Publication
(10) Pub. No.: US 2026/0326398 A1
(43) Pub. Date: Oct. 22, 2026

(54) METHOD OF FABRICATING CONTINUOUSLY VARIABLE OPTICAL FILTERS VIA INKJET PRINTING

(71) Applicant: KARLSRUHER INSTITUT FÜR TECHNOLOGIE, Karlsruhe (DE)

(72) Inventors: Qiaoshuang ZHANG, Karlsruhe (DE); Qihao JIN, Karlsruhe (DE); Ulrich LEMMER, Karlsruhe (DE)

(21) Appl. No.: 19/484,049

(22) PCT Filed: Jun. 20, 2024
(86) PCT No.: PCT/EP2024/067289

§ 371 Date: Nov. 13, 2025

(30) Foreign Application Priority Data
Jun. 23, 2023 (DE) 10 2023 116 563.1

(51) Int. Cl. B29D 11/00; B33Y 10/00; B33Y 80/00; G02B 5/20

(52) U.S. Cl. CPC B29D 11/00634; B33Y 10/00; B33Y 80/00; B29K 2995/0006; G02B 5/20

(57) ABSTRACT

The present invention relates to a method for manufacturing a continuously variable optical filter via inkjet printing, an optical component obtainable by such method, and uses of such optical component.

WO

The present invention relates to a method for manufacturing a continuously variable optical filter via inkjet printing, the method comprising the steps of providing a substrate, as well as applying and solidifying a first and at least a second dielectric layer of variable thicknesses. Moreover, the present invention relates to an optical component manufactured by said method as well as a use of said optical component as a color filter, a dielectric filter/mirror, in a sensor or in thin film coating.

Optical filters are essential components in almost all optical and optoelectronic systems, such as cameras, lasers, spectroscopic systems, and optical metrology. Any optical setup requiring wavelength selectivity typically employ optical filters. To make the system compact, in terms of size and functionality, continuously variable optical filters are used.

Existing optical filters are fabricated for instance by electron beam evaporation (EBE), ion beam sputtering (IBS), or atomic layer deposition (ALD). In said methods, a high vacuum in depositing environment as well as masking technology in order to continuously vary the deposited layer thickness are required. This brings high cost and complexity to the process. Further, the deposition of more than one different material with a precisely controlled mixing ratio is technically complex and thus involves high cost in said methods, i.e., the typical price range for a single continuously variable filter starts from several hundred euros.

Further, controlling spectral response in high-quality optical filters requires controlling the layer thickness with a precision of typically less than 10 nm. When producing optical filters, controlling the layer thickness to realize the continuous variation in one or several dimensions with such precision cannot be realized by the frequently employed solution processing methods such as spin coating, blade coating, and screen printing.

More recently, inkjet printing has been applied to form optical structures on a substrate. However, the known methods apply the printing ink including dielectric constituents to obtain a layer having constant thickness, see for instance WO 2011/003987A1; A. V. Yakovlev et al. Sci. Rep. 2016, 6, 37090; and Q. Jin et al. Adv. Mater. Technol. 2022, 7, 2101026. Having no control over a variable layer thickness in at least one lateral dimension results in limited applications or inferior optical properties.

Other disadvantages of the above-described methods include that the use of masks restricts the methods to specific sizes, locations, thicknesses, and shapes; that masking results in additional cost; that the layering of different materials is exceptionally difficult or time-consuming; and that the methods require extended process time in order to produce optical filters of e.g. a larger size.

Therefore, as explained above, the known methods for manufacturing optical filters have several disadvantages. Accordingly, in view of the prior art, an object underlying the present invention is to provide a method for manufacturing a continuously variable optical filter via inkjet printing which is easily available at low cost, and which enables manufacture of a continuously variable optical filter having excellent spectral response when being used in an optical system. Moreover, it is an object of the present invention to provide an optical component manufactured by said method as well as uses of the optical component.

The solution to the above technical problems is provided by the embodiments characterized in the claims.

Accordingly, in a first aspect, the present invention relates to a method for manufacturing a continuously variable optical filter, comprising the steps of:
a) providing a substrate;
b) applying by inkjet printing a first layer of a first liquid material onto a surface of the substrate, the first layer having a uniform or continuously variable thickness in at least one lateral dimension;
c) solidifying the first layer of the first liquid material to obtain a first dielectric layer;
d) applying by inkjet printing a second layer of a second liquid material onto the first dielectric layer, the second layer having a uniform or continuously variable thickness in at least one lateral dimension; and
e) solidifying the second layer of the second liquid material to obtain a second dielectric layer;
wherein the first and second liquid materials comprise at least one dielectric constituent
and at least one of the first and the second layer has a continuously variable thickness in at least one lateral dimension.

The present inventors have conducted extensive research to provide a solution to the above problems and found that the manufacture of a continuously variable optical filter is excellently achieved by using inkjet printing in several steps. Thus, a continuously variable optical filter can be produced at low cost and at ambient conditions which exhibits excellent spectral response due to the thicknesses of its layers being adjusted with high precision.

In general, the method for manufacturing a continuously variable optical filter, includes at least 5 steps:
a) providing a substrate;
b) applying by inkjet printing a first layer of a first liquid material onto a surface of the substrate, the first layer having a uniform or continuously variable thickness in at least one lateral dimension;
c) solidifying the first layer of the first liquid material to obtain a first dielectric layer;
d) applying by inkjet printing a second layer of a second liquid material onto the first dielectric layer, the second layer having a uniform or continuously variable thickness in at least one lateral dimension; and
e) solidifying the second layer of the second liquid material to obtain a second dielectric layer;
wherein at least one of the first and the second layer has a continuously variable thickness in at least one lateral dimension.

The herein-described method allows producing optical filters via direct layer deposition by inkjet printing under ambient conditions. High vacuum chambers and expensive masks are not required for the process. Material mixing in printing ink is easily achieved at a low cost.

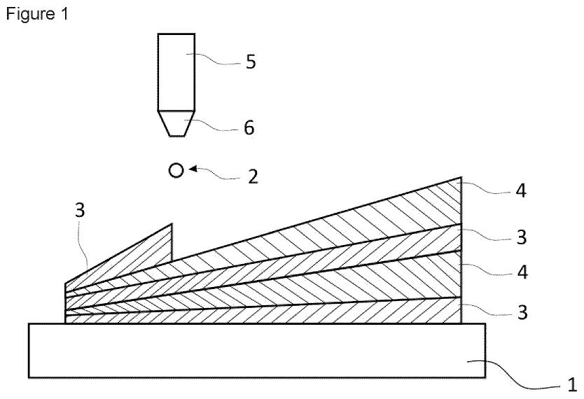

In the method for manufacturing a continuously variable optical filter, each step will be described in detail hereinafter. An exemplary inkjet printing process for manufacturing a continuously variable optical filter is illustrated in FIG. 1. However, it should be noted that some features of the exemplarily shown process relate to specific embodiments discussed below. As can be seen, FIG. 1 defines a coordinate system which will be adhered to in the following application. In this context, the terms “z direction” and “thickness direction” will be used interchangeably.

Herein, the term “continuously variable optical filter” is not particularly limiting as long as it relates to an optical filter whose optical properties vary continuously along one or several dimensions of the filter.

In step (a) of the above-defined method, a substrate is provided. The substrate may for example be a flexible foil, a rigid plate, or a top surface of a device, e.g., the top surface of an array of a photodiode, a CMOS/CCD sensor, or a solar cell. That is, the substrate may comprise or consist of various materials such as glass, polymer, or metal. Moreover, the substrate may be pre-treated to ensure sufficient adhesion of the layers being printed on top thereof or to provide suitable flow characteristics of at least the first liquid material which is applied. For example, the surface of the substrate may be cleaned, etched, hydrophobized, or hydrophilized. The surface of the substrate may also be treated and/or coated with selected chemicals, e.g., silanes or hexamethyldisilazane. The treatment of the surface of the substrate may also be applied by plasma, flame, or thermal annealing.

In step (b) of the method defined above, a first layer of a first liquid material is applied onto a surface of the substrate, wherein the first layer has a uniform or continuously variable thickness in at least one lateral dimension. That is, the thickness of the first layer may be uniform, may be continuously variable in a single lateral dimension, or may be continuously variable in more than one lateral dimension, e.g., along the x direction and a radial direction, or along several dimensions e.g., along both x and y directions.

In this context, the term “liquid material” relates to any material which is flowable at the temperature of inkjet printing as well as at room temperature (25 °C). Use of such liquid material results in excellent handling and storage properties of the material and enables an effective printing process via inkjet printing. The viscosity of such a material may be adjusted as required, for example, by using suitable solvents, dispersants, and/or matrix materials as described below.

The term “surface of the substrate” is not particularly limited and includes the whole surface of the substrate, one or more surfaces of the substrate (i.e., main surfaces or side surfaces of a plate for instance), or even only portions of one surface. Thus, the expression “surface of the substrate” is not limited to full coverage of the substrate.

In inkjet printing, the liquid material is printed by propelling little droplets from a printhead of an inkjet printer. The droplets are ejected from the printhead via nozzles. In the example presented in FIG. 1, the printhead comprises several nozzles. Typically, printheads as developed for conventional inkjet printing may be used or may be adapted for printing the layers of liquid materials as described herein. By consecutively depositing droplets on the surface of the substrate manipulated by digital control of the printer, a layer of liquid is successively generated on the surface. Generally, by manufacturing an optical filter via inkjet printing, said manufacturing process is both easily available as well as cost effective, while maintaining high precision and reliability required for providing optical components.

The droplets deposited on the surface of the substrate may have volumes of less than 100 nL, preferably less than 10 nL, less than 1 nL, less than 200 pL, less than 50 pL, less than 10 pL, or even less than 10 fL. The same applies for inkjet printing other layers which will be explained below.

In step (c) of the above-defined method, the first layer of the first liquid material is solidified to obtain a first dielectric layer. Since the first layer is solidified prior to applying further liquid material, mixing of the liquid materials is prevented.

After solidification of the first layer of the first liquid material at least a second layer of a second liquid material is applied, wherein the second layer has a uniform or continuously variable thickness in at least one lateral dimension (cf. step (d) of the above-defined method). As above, the second layer may have a continuously variable thickness in more than one lateral dimension, which may be the same or different from the lateral dimension of the first layer.

Generally, at least one of the first and the second layer has a continuously variable thickness in at least one lateral dimension in order to achieve the herein-described effects of the present invention.

In step (e) of the method defined above, the (at least) second layer of the second liquid material is solidified to obtain (at least) a second dielectric layer.

According to the first aspect of the present invention, the first and the second liquid materials independently comprise at least one dielectric constituent. The dielectric constituent is required to achieve interactions of the resulting optical filter with light incident onto said filter, which is required for the optical filter to exert its functions. Dielectric constituents include for example acrylic polymers, vinylic polymers, or inorganic substances such as oxides. In view of solubility and/or dispersibility the dielectric constituents are preferably selected from the group consisting of poly(methyl methacrylate) (PMMA), polystyrene (PS), poly(vinyl alcohol) (PVA), liquid crystals, inorganic particles such as particles of silica (SiO₂), zinc dioxide (ZnO₂), titanium dioxide (TiO₂), alumina (Al₂O₃), zirconia (ZrO₂), vanadium oxide (VOₓ), tungsten(VI) oxide (WO₃), magnesium oxide (MgO), cerium dioxide (CeO₂), silicon monoxide (SiO), titanium oxide (Ti₃O₅), titanium(III) oxide (Ti₂O₃), hafnium oxide (HfO₂), yttrium(III) oxide (Y₂O₃), calcium fluoride (CaF₂), barium fluoride (BaF₂), magnesium fluoride (MgF₂), cerium(III) fluoride (CeF₃), silicon (Si), germanium (Ge), tellurium (Te), zinc selenide (ZnSe), zinc sulfide (ZnS), lead sulfide (PbS), lead selenide (PbSe), cadmium selenide (CdSe), cadmium sulfide (CdS), cadmium telluride (CdTe), lead telluride (PbTe), indium arsenide (InAs), indium phosphide (InP), silicon nitride (Si₃N₄), aluminum nitride (AlN), cryolite, oxides, and fluorides of lanthanides or rare earths, and combinations thereof.

The liquid material preferably comprises dielectric constituents in an amount of less than 50%, more preferably less than 20%, or even less than 10% and in an amount of at least 0.01%, preferably of at least 0.1%. In this context, all percentages given are vol-%. For instance, dielectric constituents may be comprised in a range of 1% to 5% or 2% to 4%. Preferably, the liquid comprises a low amount of optically absorbing constituents or is free of such components. For example, optically absorbing constituents may preferably form less than 10%, more preferably less than 5%, less than 2%, or less than 1% of the liquid material. In other words, the liquid material is preferably optically transparent with a transparency of preferably more than 90%, more than 95%, more than 98%, or more than 99%.

According to a specific embodiment, the method as described above is characterized by that the first and second liquid materials further comprise a solvent and/or a fluid matrix material. In this context, exemplary solvents include 1,3-dimethoxybenzene, cyclopentanone, cyclohexanone, isopropanol, cyclohexane, o-xylene, hexylbenzene, triethylene glycol monomethyl ether, 2-propoxyethanol, chlorobenzene, dichlorobenzene, ethyl acetate, dimethyl sulfoxide, toluene, water, N-methyl-2-pyrrolidone, butanone, ethylene glycol, propylene glycol methyl ether, dimethylacetamide, or combinations thereof. Preferably, the solvent is 1,3-dimethoxybenzene.

Including further constituents may be necessary depending on the type of dielectric constituents comprised in the liquid materials in order to ensure a flowable printing ink for inkjet printing. For instance, extra humectant may be added to the ink, e.g., glycerol, 1,3-propanediol, 1,2-propanediol, diethylene glycol, propylene glycol or triethylene glycol. Further, extra surfactant may be added to the ink, e.g., Triton X series, BYK-346, or BYK-333. In this context, it is preferable that the dielectric constituent comprised in the first liquid material is soluble or dispersible in a solvent comprised in the first liquid material but insoluble in a solvent comprised in the second liquid material. Applying such composition and dissolution behavior ensures that applying each subsequent liquid material does not dissolve the dielectric constituents of the already solidified underlying dielectric layer. Thus, clear and sharp interfaces between the dielectric layers can be achieved enhancing sharpness of changes in optical properties between layers.

A further specific embodiment relates to the method as defined above, wherein the first liquid material and the second liquid material comprise dielectric constituents having different refractive indices and/or dielectric constituents having different concentrations. By using dielectric constituents having different refractive indices and/or different concentrations, the optical properties of the dielectric layers are adjusted such that optical processes occurring at the interfaces between said layers can be tuned specifically. Thus, the spectral response of the manufactured optical component is influenced by the type of dielectric constituents as well as by the sequence of dielectric layers.

Thus, in one embodiment, the dielectric constituents of each of the first and second (and/or of the third) liquid material are different from each other. Alternatively, the dielectric constituents are the same but are printed to achieve different porosity in the film resulting in a refractive index contrast. For example, the dielectric constituents in the various liquid materials may be selected such that a refractive index of the first dielectric constituent differs from a refractive index of the second constituent by at least 0.1, preferably at least 0.4, or at least 1.0. Having such different refractive indices in the dielectric layers, the optical characteristics of the optical filter may be tuned for obtaining for instance a high optical reflectance or a high optical transmission for light irradiated with specific wavelengths.

In another embodiment, the dielectric constituents in said liquid materials are the same having different concentrations. In yet another embodiment, said dielectric constituents may even be the same having the same concentration, whereby a higher thickness of a specific material can be reached due to being repeatedly deposited and solidified. In such case, shapes of the optical filter in thickness direction might be achieved having large variations in thickness, which would not be possible by providing thinner dielectric layers.

According to specific embodiment, further to steps (d) and (e), the above-defined method may include additional corresponding steps (f) and (g), wherein a third layer of a third liquid material is inkjet-printed onto the second dielectric layer (step (f)). Said optional step (f) is then followed by a solidifying step (g) to obtain a third dielectric layer. Just like to first and second layers, the optional third type of layer also has a uniform or continuously variable thickness in at least one lateral dimension and may have a continuously variable thickness in more than one lateral dimension. Providing a third dielectric layer enables improved fine tuning of optical properties of the manufactured optical component which is connected to excellent spectral response in an optical system.

As explained above and below, the properties of the first and second liquid materials as well as the first and second layer/dielectric layer also apply to the respective third liquid material/layer/dielectric layer. That is, the third liquid material comprises at least one dielectric constituent as described above.

A specific embodiment relates to the method as defined above, wherein the continuously variable thicknesses of the first and/or second layers are adjusted by one or more of varying the distance between liquid droplets applied during inkjet printing (process 1), varying the volume of liquid droplets applied during inkjet printing (process 2), and varying the number of liquid droplets applied during inkjet printing on the identical position (process 3). Each of said processes enables precise and reliable adjustment of the layer thickness of the printed layers resulting in excellent and consistent optical properties of an optical component manufactured by the described method. Said processes will be described in more detail in the following.

### Process 1: Dot-Per-Inch Method

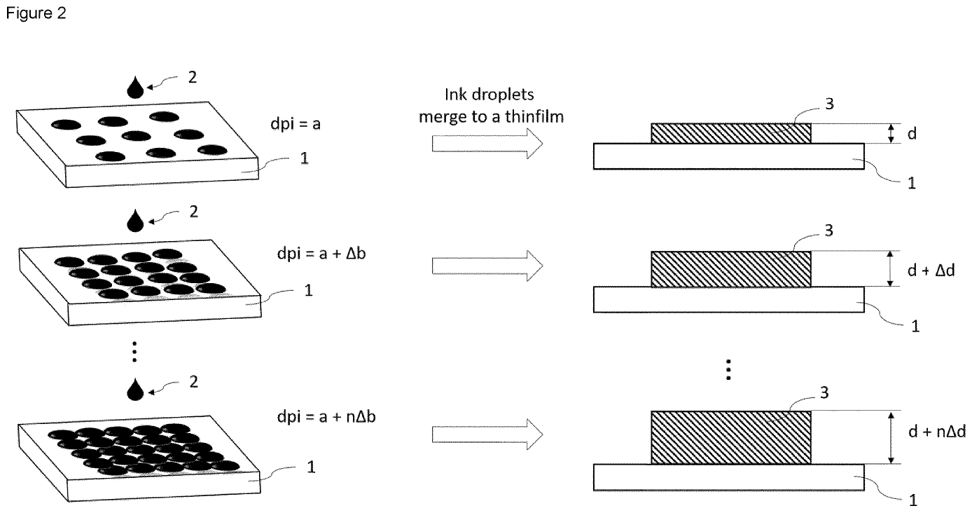

Process 1 defines a way to control the deposited layer thickness in continuously variable optical filters by printing with different dot-per-inch (dpi) on a unit area. That is, the dot-per-inch defines how many droplets of ink are applied to a predetermined area. Said process is shown schematically in FIG. 2. After being printed on a substrate, ink droplets will merge into a thin film. An increasing printing dpi leads to an increased solid thin film thickness. The Δd is the increasing step of the thickness, which results from Δb, the increasing step of dpi. By printing with different dpi in a lateral direction, the deposited layer thickness in continuously variable optical filters can be controlled. The resolution of thickness control is in the nanometer scale and Δd is in the range of sub-nanometers to micrometers.

### Process 2: Halftone Method

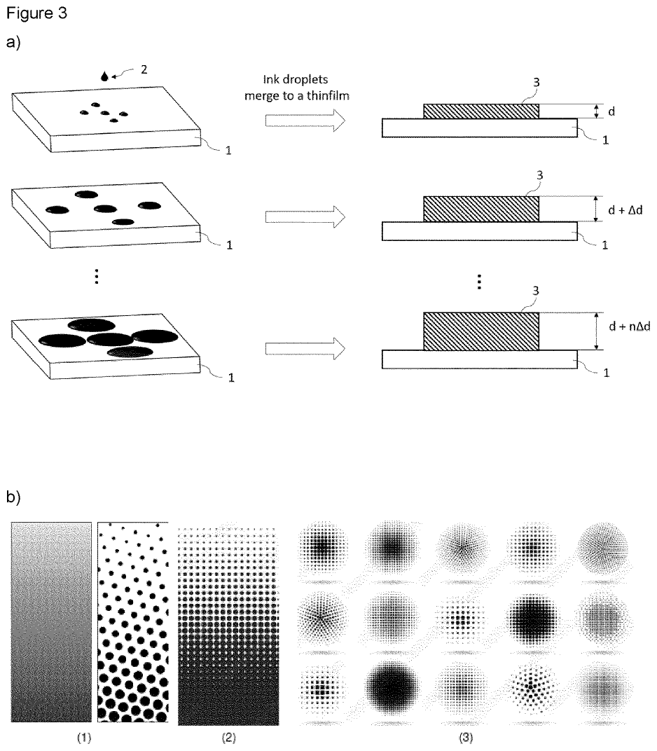

Process 2 defines a way to control the deposited layer thickness in continuously variable optical filters by printing with different halftone patterns. Said process is illustrated schematically in FIG. 3a. Halftone is a reprographic technique, reforming a continuous-tone image by dots, as shown in FIG. 3b (1). FIG. 3b (2) and (3) are typical examples of halftone patterns, where the dots are usually in different sizes. The shapes of the dots can be round, triangular, square, star-shaped, or random. FIG. 3a shows the halftone method in the inkjet printing process. By printing different dot sizes on the surface of a substrate, the thin film thickness is controlled with a resolution of Δd.

### Process 3: Greyscale Method

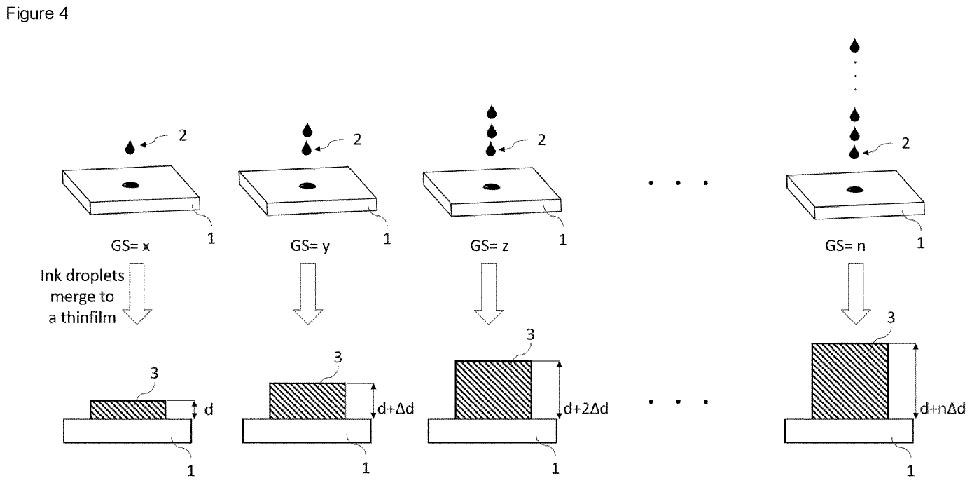

Process 3 defines a way to control the deposited layer thickness in continuously variable optical filters by printing with different greyscales (GS). This process is shown in FIG. 4. The GS in printing defines how many droplets are printed at the same position on the substrate. The GS can be a value x out of another value n. In this context, x means the current setting of the GS, and n means the total amount of possible levels. For instance, a GS can be 64 out of 255, i.e., the current GS is 64 and the total available GS value is 255. In inkjet printing, typically, the maximum number of droplets that can be printed on the same position with the consideration of final thin film formation quality is 256. For example, by printing with GS of 55, the thin film thickness is larger than e.g., with GS of 195. Variation of GS leads to a thickness change, wherein the resolution is defined by Δd.

Moreover, it has been found that the exact volume of one droplet is difficult to control. Thus, in order to increase controllability, more than one droplet may be deposited onto the same location according to the described GS method. Thereby, statistical effects regarding the droplet volumes may result in the liquid layer being printed with a more homogeneous layer thickness.

For controlling deposited thin film thickness, the dot-per-inch method, greyscale method, and halftone method can be applied individually or may be combined. By employing a combination of said processes even more control can be exerted on optical properties of the resulting optical component.

A specific embodiment of the present invention relates to the above-described method, wherein independently the thickness of each of the first, second, and optional third dielectric layers is preferably less than 10 μm, less than 1 μm, less than 500 nm, less than 200 nm and even less than 100 nm. Said thickness has an influence on reflection and refraction of incoming light in optical applications of the resulting optical component. Thus, a thickness in the above range is excellently suited for being used in combination with a variety of wavelengths of light occurring in various optical applications, particularly for being used in combination with visible, UV, or infrared light.

Preferably, the thickness precision of inkjet printing each layer is less than 20 nm, more preferably less than 10 nm, less than 5 nm, and even more preferably less than 1 nm. In this context, the thickness precision is defined as the variation of thickness in an area having the same predetermined thickness. The thickness precision is a direct result of optimizing the ink formulation and printing parameters, such as e.g., the precision of droplet volume or precision of the location, where the droplets are deposited. Ensuring the above thickness precision improves the optical component's applicability in advanced optical setups due to consistent optical properties and performance.

Moreover, it is preferred that the thickness is adjusted without the use of masking as is commonly required in conventional methods. Further, the above-described method is preferably conducted at ambient conditions, that is without applying reduced pressure or even vacuum. Both of said advantages allow the method of the present invention to be easily available and cost efficient.

A further specific embodiment relates to the method defined above, wherein steps (b) to (e) are repeated at least once to obtain a stack of alternating dielectric layers. That is, said steps may be repeated, for example, once, twice, five times, ten times or even more than one hundred times. By repeating said steps multiple times, a stack of dielectric layers each having a continuously variable thickness is generated. This stack comprises an alternating layer sequence of dielectric layers comprising the dielectric constituents of the first, second, and optionally third liquid materials. Stacking the above layers by repetition of steps (b) to (e) for instance enables enhanced adjustment of the manufactured optical component to specific optical setups.

Moreover, in a further embodiment, also the optional steps (f) and (g) concerning the deposition of a third layer may be repeated as desired. However, according to the present invention, each of the corresponding applying and solidifying steps of the individual layers (b) and (c), (d) and (e) and optionally (f) and (g) may be repeated independently from each other.

Examples of such stacks include setups such as (S/A/B/A/B . . . ), (S/A/B/C/A/B/C . . . ), (S/A/B/A/B/C/A/B/A/B/C . . .), (S/A/A/B/B/A/A/B/B . . . ), (S/A/B/C/C/A/B/C/C . . . ), (S/A/B/B/A/B/B . . . ), etc., wherein S represents the substrate, A represents the first layer, B represents the second layer and C represents the optional third layer. The number of total layers is not particularly limited and is adjusted according to the desired application. In this context, the above-mentioned exemplary stacks refer to materials A, B, and C, wherein the respective thickness of each layer may be adjusted independently from other layers, i.e., different layers of A may have different thicknesses and the same applies for B and C.

In another specific embodiment, the method of the present invention may include a step (h) of providing a protective layer on the top surface of the continuously variable optical filter. The protective layer is not particularly limited as long as it exerts a protective function and is sufficiently transparent to incident light being used in the targeted application. Thus, a protective layer may be scratch-resistant, resistant to ambient conditions such as moisture and high-intensity light irradiation.

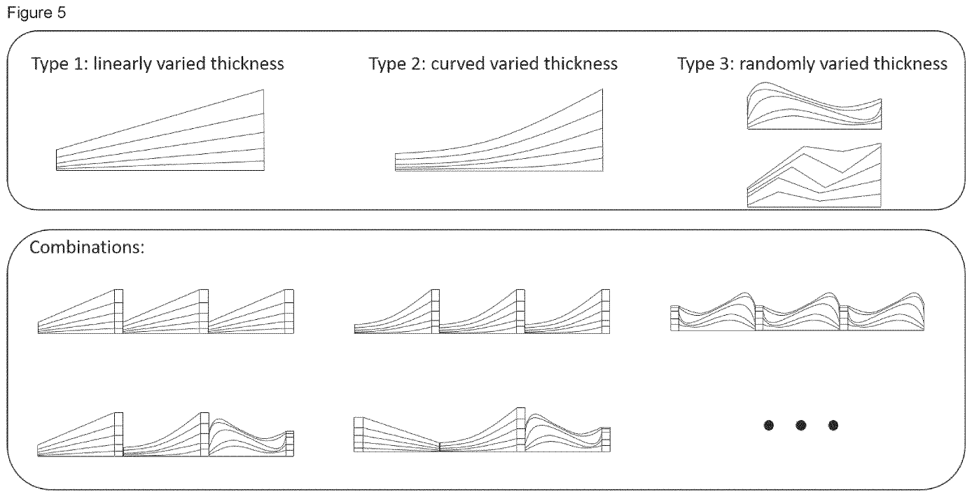

Moreover, a specific embodiment relates to the method as described above, wherein the cross-sectional shape of the optical filter in a thickness direction is linearly varied, curved varied, or randomly varied and/or the cross-sectional shape of any of the first and second layers (or the third layer) in a thickness direction is linearly varied, curved varied, or randomly varied. That is, the cross-sectional shape of the optical filter means the profile of the filter in thickness direction. Exemplary shapes of the optical filter are depicted in FIG. 5. Lateral layer thickness variation can be of any shape such as linear, exponential, or random. In different application scenarios, a combination of the above shapes can be used. Further, different shapes can be combined in a lateral direction, i.e., patches of different shapes beside each other, or even in thickness direction, i.e., different thickness variation of layers on top of each other. In this context, the adjusting the cross-sectional shape of the optical filter in a thickness direction renders it feasible to adjust said filter to a variety of different applications in optical setups.

In a preferred embodiment of the above-described method, the thickness of the optical filter and/or any of the first and second (and optionally third) layers continuously increases in at least one lateral dimension, wherein said lateral dimension is the same for each layer. Such configuration may result in a wedge-type optical filter, which is exemplarily shown in FIG. 1. Said variable optical filter may be used, e.g., in spectrometers and sensors, including the use for spectral-based imaging, multi- and hyper-spectral applications, microscopes, including fluorescence-based applications. That is, variable optical filters are advantageous in these applications by achieving a more compact system instead of combining several different optical filters.

In another specific embodiment according to the first aspect of the present invention, the method is as described above, wherein the solidifying steps (c) and (e) (and optional solidifying step (g)) independently include one or more of drying, curing, heating, irradiating, or a combination thereof. Employing such techniques results in effective drying of the liquid material constituting the individual layers such that substantially all volatile constituents are evaporated. These measures may further be carried out under reduced pressure, if desired. Alternatively or additionally, any polymers or polymer precursors comprised in the liquid material may be solidified by using visible or UV light, thereby cross-linking and curing the polymers/precursors. The solidification method is not limited to the above methods and may further include e.g., annealing or sintering of solid particles and the like. Thus, the type of solidifying process is chosen depending on the combination of dielectric constituent and optionally solvent/fluid matrix material in each liquid material. That is, for instance, if the dielectric constituent is a polymerizable monomer, solidification may be conducted by irradiating resulting in cross-linking, if the dielectric constituent is an inorganic particle dispersed in a solvent, solidifying may be conducted by drying and/or heating to evaporate said solvent, or even if the dielectric constituent is an inorganic particle dispersed in a polymerizable fluid matrix material, solidifying of the matrix may be conducted by irradiating resulting in cross-linking of the matrix.

In this context, the term “irradiating” relates to irradiation with light which includes for example visible light (i.e., having a wavelength of 400 to 800 nm), ultraviolet light (i.e., having a wavelength of 150 to 400 nm), infrared light (i.e., having a wavelength of 800 to 3000 nm), or light having other wavelengths being suited to cause solidification of at least part of a liquid material. Moreover, the term “heating” means exposing a liquid material to elevated temperatures of for instance at least 40 °C, at least 100 °C, or at least 200 °C. Other technologies can be used for surface solidification, including applying plasma, vacuum, ultrasonic wave, and/or embossing.

A second aspect of the present invention relates to an optical component manufactured by the above-defined method.

Such optical component may include, for example, a bandpass filter, a dichroic filter, a longpass filter, a shortpass filter, a notch filter, a response-flattening filter, a neutral density filter, a beam splitter, a polarizer, an antireflective coating, or a waveplate. Said optical component further includes a substrate coated with an anti-reflection function.

Using the above-defined method for manufacturing an optical component ensures excellent spectral response of said optical component when being used in an optical system.

A third aspect of the present invention relates to the use of the above optical component as a color filter, a dielectric filter/mirror, a sensor, or in thin film coating.

The figures show:

FIG. 1 shows a schematic exemplary inkjet printing process for manufacturing a continuously variable optical filter. Multiple layers (3) and (4) are alternately stacked on the substrate (1). The layers are formed by ejecting droplets (2) from the printhead (5) through nozzles (6).

FIG. 2 illustrates the general process of varying the distance between liquid droplets applied during inkjet printing (dot-per-inch method) in order to control the deposited layer's thickness.

FIG. 3a shows the general process of varying the volume of liquid droplets applied during inkjet printing (halftone method) in order to control the deposited layer's thickness.

FIG. 3b depicts exemplary halftone patterns.

FIG. 4 illustrates the general process of varying the number of liquid droplets applied during inkjet printing on the identical position (greyscale method) in order to control the deposited layer's thickness.

FIG. 5 shows exemplary profiles of printed continuously variable optical filters in z direction.

Specifically, the optical component may be used as a color filter e.g., for camera chips; as a dielectric filter/mirror for various optical systems, particularly devices requiring optical properties in large areas; in integrated spectrometers for optical sensing; in photovoltaic modules with aesthetic appearance e.g., a logo; and for light management films of displays. Typically, such optical components are in use in industries relating to optical systems, optoelectronics, sensors, photovoltaics, or in thin film coating.

1. A method for manufacturing a continuously variable optical filter, comprising the steps of:
a) providing a substrate;
b) applying by inkjet printing a first layer of a first liquid material onto a surface of the substrate, the first layer having a uniform or continuously variable thickness in at least one lateral dimension;
c) solidifying the first layer of the first liquid material to obtain a first dielectric layer;
d) applying by inkjet printing a second layer of a second liquid material onto the first dielectric layer, the second layer having a uniform or continuously variable thickness in at least one lateral dimension; and
e) solidifying the second layer of the second liquid material to obtain a second dielectric layer;
wherein the first and second liquid materials comprise at least one dielectric constituent
and at least one of the first and the second layer has a continuously variable thickness in at least one lateral dimension.

2. The method according to claim 1, wherein the continuously variable thicknesses of the first and/or second layer are adjusted by varying the distance between liquid droplets applied during inkjet printing.

3. The method according to claim 1, wherein steps b) to e) are repeated at least once to obtain a stack of alternate dielectric layers.

4. The method according to claim 1, wherein the cross-sectional shape of the optical filter in a thickness direction is linearly varied, curved varied, or randomly varied and/or the cross-sectional shape of any of the first and second layers in a thickness direction is linearly varied, curved varied, or randomly varied.

5. The method according to claim 1, wherein the thickness of the optical filter and/or any of the first and second layers continuously increases at least one lateral dimension.

6. The method according to claim 1, wherein the first and second liquid materials further comprise a solvent and/or a fluid matrix material.

7. The method according to claim 1, wherein the first liquid material and the second liquid material comprise dielectric constituents having different refractive indices and/or dielectric constituents having different concentrations.

8. The method according to claim 1, wherein the solidifying steps c) and e) independently include one or more of drying, curing, heating, irradiating, or a combination thereof of the first and second layers.

9. An optical component manufactured by the method according to claim 1.

10. Use of the optical component according to claim 9 as a color filter, a dielectric filter/mirror, or in a sensor, or in thin film coating.

11. The method according to claim 1, wherein the continuously variable thicknesses of the first and/or second layer are adjusted by varying the volume of liquid droplets applied during inkjet printing.

12. The method according to claim 1, wherein the continuously variable thicknesses of the first and/or second layer are adjusted by varying the number of liquid droplets applied during inkjet printing on the identical position.
